(19) United States
(12) Patent Application Publication
(10) Pub. No.: US 2015/0090402 A1
(43) Pub. Date: Apr. 2, 2015

(54) TRACING FIGURES FROM A DISPLAY OF AN ELECTRONIC DEVICE

(71) Applicant: Luis Javier Pagan, Dublin, OH (US)

(72) Inventor: Luis Javier Pagan, Dublin, OH (US)

(21) Appl. No.: 14/043,821

(22) Filed: Oct. 1, 2013

(51) Int. Cl. B32B 37/24; C09J 5/00; B32B 37/12; C09J 7/02

(52) U.S. Cl. CPC B32B 37/24; C09J 7/02; C09J 5/00; B32B 37/12; C09J 2203/326; C09J 2201/122; C09J 2201/16; B32B 2037/243
USPC 156/280; 428/343; 428/220; 427/207.1

(57) ABSTRACT

A manufacture for tracing figures from a display of an electronic device includes a sheet of transparent or semitransparent material having a shape corresponding to the electronic device or the display, and first and second sides. The first and second sides include a tracing area in which a figure displayed on the display is visible in the tracing area through the transparent or semitransparent material. The manufacture for tracing figures from a display of an electronic device also includes an adhesive applied to a portion of the second side of the sheet for the manufacture to adhere to the electronic device or the display such that the figure displayed on the display of the electronic device is visible in the tracing area through the transparent or semitransparent material such that a user may trace the figure on the tracing area by marking the first side with a writing device.

### FIELD OF THE INVENTION

The present disclosure relates generally to electronic devices and particularly to mobile electronic devices such as mobile telephones, tablets, and similar devices. More particularly, the present disclosure relates to tracing figures from a display of an electronic device.

### BACKGROUND

Conventional tracing paper allows designers and artists to trace an image from a book, magazine, or other paper-based documents onto it. Conventional tracing paper is placed onto the document, and pictures on the document are viewable through the tracing paper. The artist may see the edges of the pictures and trace them onto the tracing paper.

Electronic devices and mobile electronic devices in particular are ever increasing in popularity. In many fields, these devices have come to replace paper based documents. Conventional tracing paper, however, does not work well with electronic devices.

Thus, there is a need in the art for methods and devices that may allow for tracing figures from a display of an electronic device.

### SUMMARY OF THE INVENTION

This disclosure provides manufactures and methods for tracing figures from a display of an electronic device. The manufactures may be installed on the electronic device such that figures displayed on the display of the electronic device are visible on the surface of the manufactures such that a user may trace the figure on the manufacture by marking it with a writing device.

At the outset it is important to understand that conventional tracing paper just does not work properly with electronic devices. First, conventional tracing paper is not of the correct size and thus, if one attempts to use conventional tracing paper to trace figures from a display of an electronic device, excess paper hangs off the edges of the electronic device making the tracing difficult, uncomfortable and inconvenient. Moreover, conventional tracing paper provides fairly stable conditions on paper-based documents because friction between the tracing paper and the paper-based document held the tracing paper generally in place. Conventional tracing paper, however, is not stable when used with displays of electronic devices because the displays are typically smooth and slick and thus provide for very little friction between the tracing paper and the display. Conventional tracing paper slides on the smooth and slick surfaces of these devices presenting unstable conditions that are less than optimal for tracing.

Products that resemble sticky notes (e.g., 3M Post-it notes) exist that may be used for tracing. However, even if something like sticky notes was to be used for tracing from the display of an electronic device, these notes are not of the correct size and moreover adhere only at one end. Thus, when tracing, the paper tends to move and/or wrinkle. This makes it difficult and tedious to trace the figure, again presenting unstable conditions that are less than optimal for tracing.

The manufacture for tracing figures from a display of an electronic device of the present disclosure includes a sheet of transparent or semitransparent material that has a shape corresponding to the electronic device or the display. The first side of the sheet includes a tracing area in which a figure displayed on the display is visible in the tracing area through the transparent or semitransparent material. The manufacture also includes an adhesive applied to a portion of the second side of the sheet so that the manufacture adheres to the electronic device or the display creating a stable condition for tracing. A user may confidently trace the figure on the tracing area by marking the first side with a writing device.

These and further features of the present invention will be described with reference to the attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the terms of the appended claims.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIGS. 1A-1C illustrate front, side and perspective views of an exemplary manufacture for tracing figures from a display of an electronic device.

FIGS. 1D-1F illustrate front, side and perspective views of the exemplary manufacture of FIGS. 1A-1C installed on an electronic device.

FIGS. 1G-1J illustrate rear views of the exemplary manufacture for tracing figures from a display of an electronic device of FIGS. 1A-1C.

FIGS. 2A-2C illustrate front, side and perspective views of an exemplary manufacture for tracing figures from a display of an electronic device.

FIGS. 2D-2F illustrate front, side and perspective views of the exemplary manufacture of FIGS. 2A-2C installed on an electronic device.

FIGS. 2G-2J illustrate rear views of the exemplary manufacture for tracing figures from a display of an electronic device of FIGS. 2A-2C.

FIGS. 3A-3C illustrate front, side and perspective views of an exemplary manufacture for tracing figures from a display of an electronic device.

FIGS. 3D-3F illustrate front, side and perspective views of the exemplary manufacture of FIGS. 3A-3C installed on an electronic device.

FIGS. 3G-3J illustrate rear views of the exemplary manufacture for tracing figures from a display of an electronic device of FIGS. 3A-3C.

### DETAILED DESCRIPTION

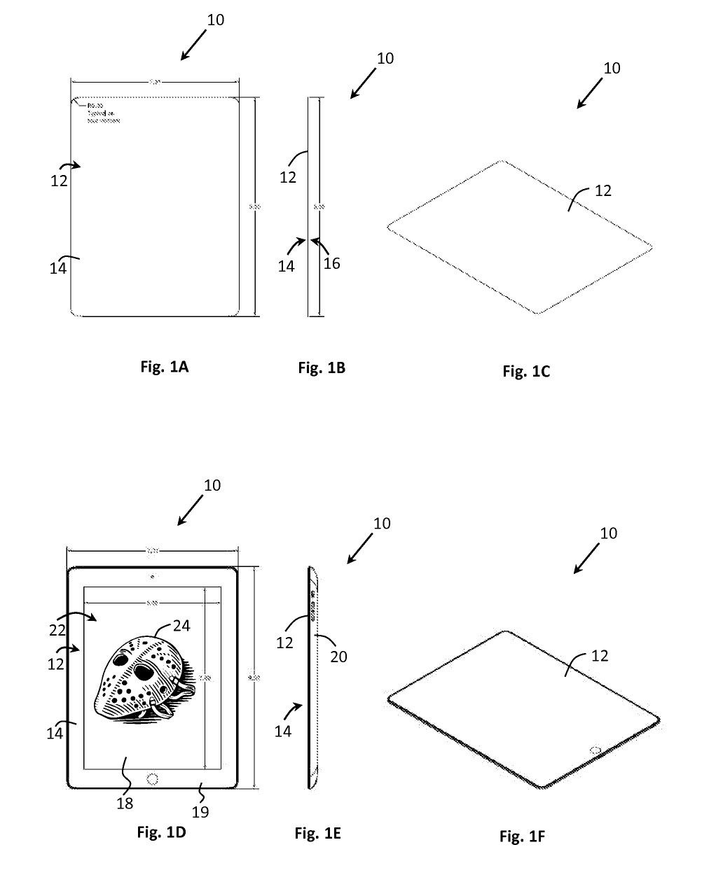

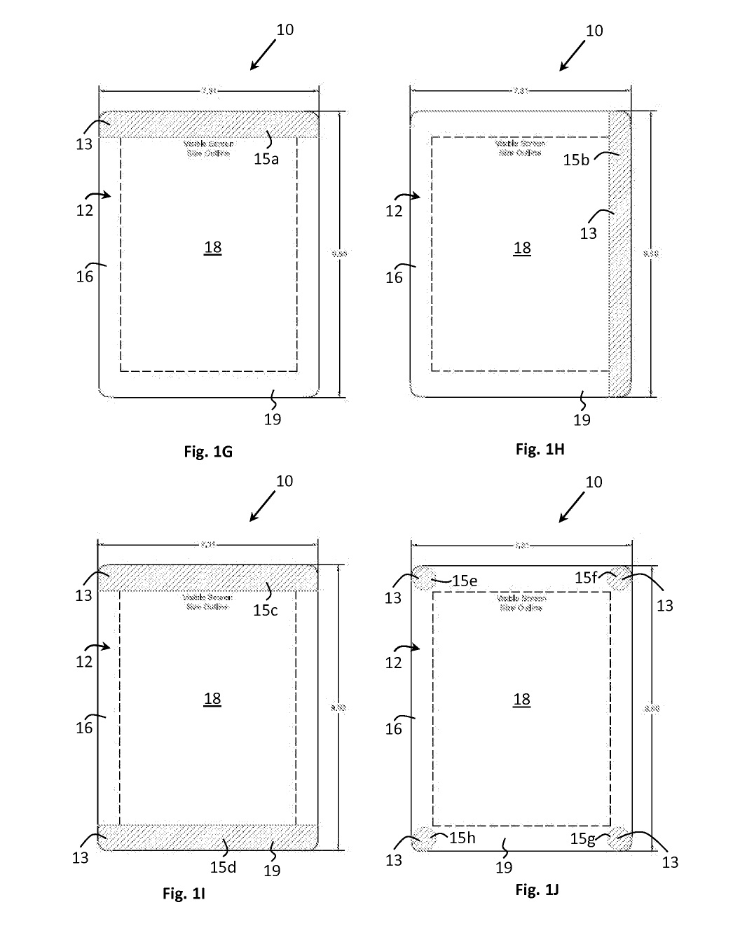

FIGS. 1A-1J illustrate an exemplary manufacture 10 for tracing figures from a display 22 of an electronic device 20.

As illustrated in FIGS. 1A-1C, the manufacture 10 includes a sheet 12. The sheet 12 has a first side 14 and a second side 16.

The sheet 12 is made of a transparent or semitransparent material. The material may be the same or similar material as that used for tracing paper, which is made to have low opacity, allowing light to pass through. The material may also be transparent paper or transparent plastic material. Potential materials for the sheet 12 include cellulose fiber (e.g., wood fiber, cotton fiber, etc.) as well as synthetic or semi-synthetic organic polymers, for example. The material of the sheet 12 may be uncoated or coated with additional materials to obtain specific desired characteristics.

FIGS. 1D-1F illustrate the exemplary sheet 12 in its environment including the electronic device 20. In the illustrated embodiment, the sheet 12 has a shape that corresponds to the shape of a specific electronic device 20. In another embodiment (not shown), the sheet 12 has a shape that corresponds to the shape of the display 22 of the specific electronic device 20. In yet other embodiments (not shown), the sheet 12 may have shapes corresponding to shapes other than those of the electronic device 20 or the display 22 of the electronic device 20.

In the illustrated embodiment of FIGS. 1A-1J, the specific electronic device 20 is a fourth generation Apple® iPad. Thus, in the illustrated embodiment of FIGS. 1A-1J, the sheet 12, since it has the shape of the specific electronic device 20, has a shape that corresponds to a fourth generation Apple® iPad. In the illustrated embodiment, the dimensions of the sheet 12 are approximately 9.50 inches by 7.31 inches. In other embodiments, the dimensions of the sheet 12 are different from 9.50 inches by 7.31 inches depending on the specific electronic device to which the manufacture 10 is to be applied.

As described in detail below, however, in other embodiments, the specific electronic device may be devices other than a fourth generation Apple® iPad and thus the sheet may have a shape that corresponds to the specific electronic device other than the fourth generation Apple® iPad. Therefore, it should be understood that the features of the disclosed invention are available for other electronic devices.

Also, although in the illustrated embodiment of FIGS. 1A-1J, the sheet 12 has the shape of the specific electronic device 20, a fourth generation Apple® iPad, in other embodiments (not shown), the sheet has a shape that corresponds to the display 22 of a fourth generation Apple® iPad or the display of a specific electronic device other than the fourth generation Apple® iPad. Thus, in one embodiment, the sheet 12 has dimensions of approximately 7.80 inches by 5.85 inches. In other embodiments, the dimensions of the sheet 12 are different from approximately 7.80 inches by 5.85 inches depending on the specific electronic device to which the manufacture 10 is to be applied.

As illustrated in FIGS. 1D-1F, the first side 14 and the second side 16 include a tracing area 18. When the manufacture 10 is installed to the electronic device 20 the tracing area 18 substantially aligns with the display 22 of the electronic device 20 and the size of the tracing area 18 substantially corresponds to the size of the display 22. In the illustrated embodiment, the tracing area 18 has dimensions of approximately 7.80 inches by 5.85 inches. In other embodiments, the dimensions of the tracing area 18 are different from approximately 7.80 inches by 5.85 inches depending on the specific electronic device to which the manufacture 10 is to be applied.

In one example, for a 16:9 ratio display, the ratio of a first dimension of the tracing area 18 to a second dimension of the tracing area 18 is 16:9. In another example, for a 4:3 ratio display, the ratio of a first dimension of the tracing area 18 to a second dimension of the tracing area 18 is 4:3, and so on. Thus, figures or images, such as the FIG. 24, displayed on the display 22 of the electronic device 20 are visible in the tracing area 18 through the transparent or semitransparent material of the sheet 12.

As illustrated in FIGS. 1G-1J and described in more detail below, the manufacture 10 includes an adhesive 13 that is applied to a portion 15a-h of the second side 16 of the sheet 12. The adhesive 13 assists or allows the manufacture 10 and/or the sheet 12 to removably adhere to the electronic device 20 or the display 22 of the electronic device 20.

FIGS. 1D-1F illustrate the exemplary manufacture 10 installed or adhered to the electronic device 20 such that the FIG. 24 displayed on the display 22 of the electronic device 20 may be visible in the tracing area 18. In the illustrated embodiment of FIGS. 1D-1F, a user may trace the FIG. 24 onto the tracing area 18 of the manufacture 10 by marking the first side 14 with a writing device (e.g., pencil, pen, marker, etc.)

Therefore, the manufacture 10 allows a designer or artist to easily and conveniently trace an image displayed in the specific electronic device 20. When the manufacture 10 is installed onto the specific electronic device 20, the FIG. 24 displayed on the display 22 of the device 20 is easily viewable through the sheet 12. Thus, it becomes easy for the designer or artist to find edges in the FIG. 24 and trace the FIG. 24 onto the tracing area 18 of the sheet 12.

Returning to FIGS. 1G-1J, the manufacture 10 includes the adhesive 13 that is applied to at least one portion 15a-h of the second side 16 of the sheet 12.

The adhesive 13 may be a self-adhesive, which is an adhesive that bonds simply from pressure applied to the manufacture 10 against the electronic device 20 to adhere the sheet 12 to the electronic device 20. No solvent, water, or heat is needed to activate the adhesive 13. From contact and the application of pressure, the adhesive 13 forms a temporary bond between the sheet 12 and the electronic device 20 that can be removed immediately or after minutes or hours (or even after months or years) without leaving residue on the electronic device 20. The adhesive 13 may be the same or a similar adhesive as that used on 3M's Post-it® notes or on masking tape.

The adhesive 13 may be based on an elastomer compounded with a suitable tackifier (e.g., a rosin ester). The elastomers can be based on acrylics (which can have sufficient tack on their own to not require a tackifier), bio-based acrylate, butyl rubber, ethylene-vinyl acetate, natural rubber, nitriles, silicone rubber (requiring special tackifiers based on “MQ” silicate resins, composed of a monofunctional trimethyl silane (“M”) reacted with quadrafunctional silicon tetrachloride (“Q”)), styrene block copolymers, styrene-butadiene-styrene, styrene-ethylene/butylene-styrene, styrene-ethylene/propylene, styrene-isoprene-styrene, vinyl ethers, etc.

In one embodiment, the sheet 12 includes an outer area that is adjacent the tracing area 18, and the adhesive 13 is applied to a portion of the second side 16 corresponding to the outer area. In another embodiment, the sheet 12 does not include an outer area that is adjacent the tracing area 18, and the adhesive 13 is applied to a portion of the second side 16 corresponding to the tracing area. In yet another embodiment, the sheet 12 includes an outer area that is adjacent the tracing area 18, but the adhesive 13 is applied to a portion of the second side 16 corresponding to the tracing area 18 or combinations of the tracing area 18 and the outer area.

In the embodiments of FIGS. 1G-1J, the sheet 12 includes the outer area 19 that is adjacent and surrounds the tracing area 18. In the illustrated embodiment, the tracing area 18 substantially corresponds to the display 22 of the electronic device 20 and the outer area 19 corresponds to a portion of the electronic device that surrounds the display 22. The adhesive 13 is applied to portions 15a-h of the second side 16 on the outer area 19.

FIG. 1G illustrates an embodiment where the adhesive 13 is applied to portion 15a of the second side 16 on the outer area 19. The portion 15a is at or near the top edge of the sheet 12. In this embodiment, the manufacture 10 adheres to a portion of the electronic device 20 above the display 22 such that the tracing area 18 substantially aligns with the display 22.

FIG. 1H illustrates an embodiment where the adhesive 13 is applied to portion 15b of the second side 16 on the outer area 19. The portion 15b is at or near the right edge of the sheet 12. In this embodiment, the manufacture 10 adheres to a portion of the electronic device 20 right of the display 22 such that the tracing area 18 substantially aligns with the display 22. In another embodiment (not illustrated), the adhesive 13 is applied to a portion of the second side 16 that is at or near the left edge of the sheet 12. In this embodiment, the manufacture 10 adheres to a portion of the electronic device 20 left of the display 22 such that the tracing area 18 substantially aligns with the display 22.

FIG. 1I illustrates an embodiment where the adhesive 13 is applied to portions 15c and 15d of the second side 16 on the outer area 19. The portions 15c and 15d are at or near the top edge and the bottom edge, respectively, of the sheet 12. In this embodiment, the manufacture 10 adheres to portions of the electronic device 20 above and below the display 22 such that the tracing area 18 substantially aligns with the display 22.

FIG. 1J illustrates an embodiment where the adhesive 13 is applied to portions 15e, 15f, 15g and 15h of the second side 16 on the outer area 19. The portions 15e, 15f, 15g and 15h are at or near corners of the sheet 12. In this embodiment, the manufacture 10 adheres to portions of the electronic device 20 near its corners such that the tracing area 18 substantially aligns with the display 22.

The embodiments of FIGS. 1G-1J are merely exemplary and other combinations of the portions 15 to which the adhesive 13 is applied may exist. Thus, the adhesive 13 may be applied to a single portion of the second side 16 on the tracing area 18 (including the whole tracing area 18) or the outer area 19 (including the whole outer area 19) or to two or more portions of the second side 16 corresponding to non-adjacent and non-overlapping portions of the tracing area 18 or the outer area 19.

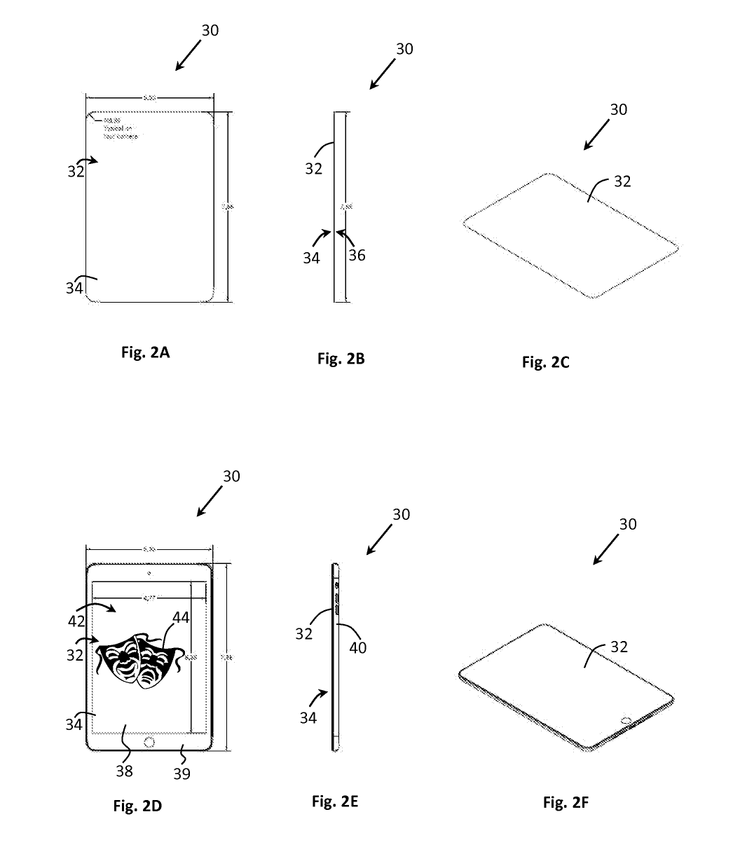

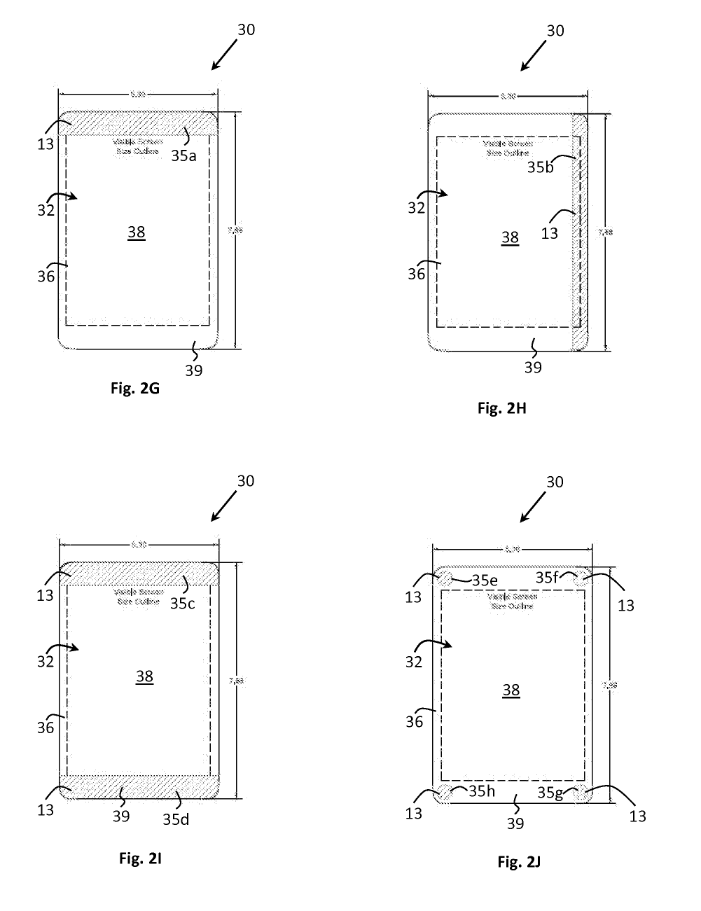

FIGS. 2A-2J illustrate an exemplary manufacture 30 for tracing figures from a display 42 of an electronic device 40. The manufacture 30 includes a sheet 32 that has a first side 34 and a second side 36. The sheet 32 is made of a transparent or semitransparent material.

FIGS. 2D-2F illustrate the exemplary sheet 32 in its environment including the electronic device 40. In the illustrated embodiment, the sheet 32 has a shape that corresponds to the shape of a specific electronic device 40, which in the illustrated embodiment of FIGS. 2A-2J is an Apple® iPad mini. Thus, in the illustrated embodiment of FIGS. 2A-2J, the sheet 32, since it has the shape of the specific electronic device 40, has a shape that corresponds to an Apple® iPad mini. In the illustrated embodiment, the dimensions of the sheet 32 are approximately 7.88 inches by 5.30 inches.

Also, although in the illustrated embodiment of FIGS. 2A-2J, the sheet 32 has the shape of the specific electronic device 40, an Apple® iPad mini, in other embodiments (not shown), the sheet has a shape that corresponds to the display 42 of an Apple® iPad mini. Thus, in one embodiment, the sheet 32 has dimensions of approximately 6.35 inches by 4.77 inches.

As illustrated in FIGS. 2D-2F, the first side 34 and the second side 36 include the tracing area 38. When the manufacture 30 is installed to the electronic device 40 the tracing area 38 substantially aligns with the display 42 of the electronic device 40 and the size of the tracing area 38 substantially corresponds to the size of the display 42. In the illustrated embodiment, the tracing area 38 has dimensions of approximately 6.35 inches by 4.77 inches.

As illustrated in FIGS. 2G-2J, the manufacture 30 includes the adhesive 13 that is applied to at least one portion 35 of the second side 36 of the sheet 32. The adhesive 13 assists or allows the manufacture 30 and/or the sheet 32 to adhere to the electronic device 40 or the display 42 of the electronic device 40.

When the manufacture 30 and/or the sheet 32 is installed to the electronic device 40 or the display 42 of the electronic device 40 figures or images, such as the FIG. 44, displayed on the display 42 of the electronic device 40 are visible in the tracing area 38 through the transparent or semitransparent material of the sheet 32.

FIGS. 2D-2F illustrate the exemplary manufacture 30 installed or adhered to the electronic device 40 such that the FIG. 44 displayed on the display 42 of the electronic device 40 is visible in the tracing area 38. In the illustrated embodiment of FIGS. 2D-2F, a user may trace the FIG. 44 onto the tracing area 38 of the manufacture 30 by marking the first side 34 with a writing device (e.g., pencil, pen, marker, etc.)

FIG. 2G illustrates an embodiment where the adhesive 13 is applied to portion 35a of the second side 36 on the outer area 39. The portion 35a is at or near the top edge of the sheet 32. In this embodiment, the manufacture 30 adheres to a portion of the electronic device 40 above the display 42 such that the tracing area 38 substantially aligns with the display 42.

FIG. 2H illustrates an embodiment where the adhesive 13 is applied to portion 35b of the second side 36 on the outer area 39. The portion 35b is at or near the right edge of the sheet 32. In this embodiment, the manufacture 30 adheres to a portion on the right of the electronic device 40 such that the tracing area 38 substantially aligns with the display 42. In another embodiment (not illustrated), the adhesive 13 is applied to a portion of the second side 36 that is at or near the left edge of the sheet 32. In this embodiment, the manufacture 30 adheres to a portion on the left of the electronic device 40 such that the tracing area 38 substantially aligns with the display 42.

FIG. 2I illustrates an embodiment where the adhesive 13 is applied to portions 35c and 35d of the second side 36 on the outer area 39. The portions 35c and 35d are at or near the top edge and the bottom edge, respectively, of the sheet 32. In this embodiment, the manufacture 30 adheres to portions of the electronic device 40 above and below the display 42 such that the tracing area 38 substantially aligns with the display 42.

FIG. 2J illustrates an embodiment where the adhesive 13 is applied to portions 35e, 35f, 35g and 35h of the second side 36 on the outer area 39. The portions 35e, 35f, 35g and 35h are at or near corners of the sheet 32. In this embodiment, the manufacture 30 adheres to portions of the electronic device 40 near its corners such that the tracing area 38 substantially aligns with the display 42.

The embodiments of FIGS. 2G-2J are merely exemplary and other combinations of the portions 35 to which the adhesive 13 is applied may exist. Thus, the adhesive 13 may be applied to a single portion of the second side 36 on the tracing area 38 (including the whole tracing area 38) or the outer area 39 (including the whole outer area 39) or to two or more portions of the second side 36 corresponding to non-adjacent and non-overlapping portions of the tracing area 38 or the outer area 39.

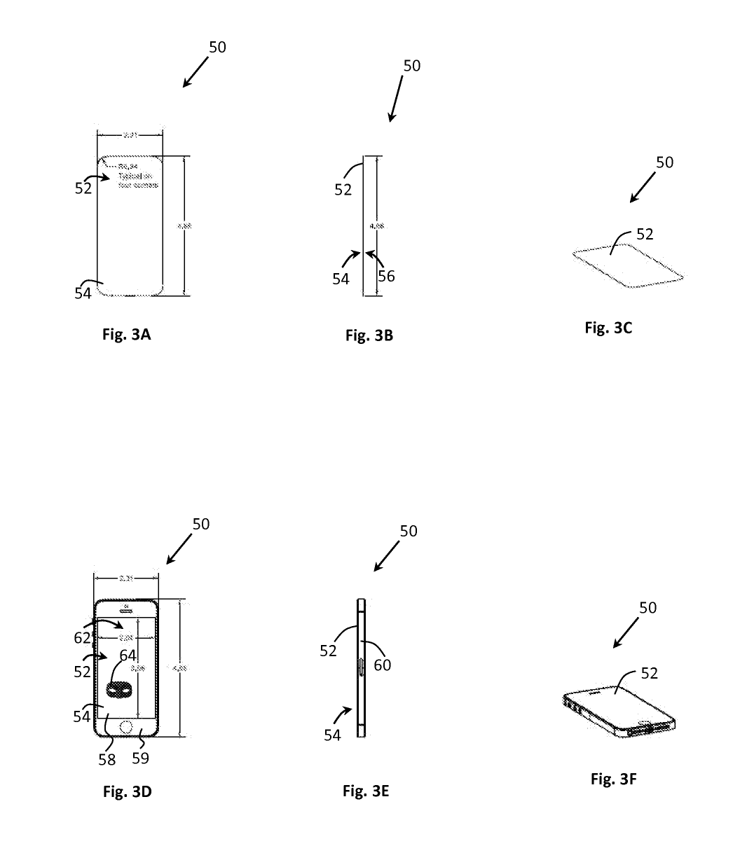

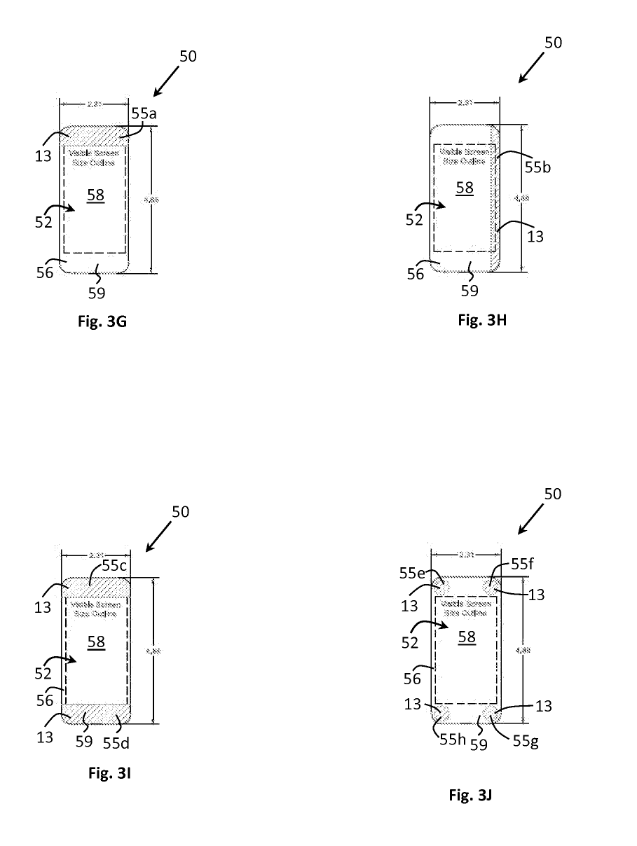

FIGS. 3A-3J illustrate an exemplary manufacture 50 for tracing figures from a display 62 of an electronic device 60. The manufacture 50 includes a sheet 52 that has a first side 54 and a second side 56. The sheet 52 is made of a transparent or semitransparent material.

FIGS. 3D-3F illustrate the exemplary sheet 52 in its environment including the electronic device 60. In the illustrated embodiment, the sheet 52 has a shape that corresponds to the shape of a specific electronic device 60, which in the illustrated embodiment of FIGS. 3A-3J is an Apple® iPhone 5. Thus, in the illustrated embodiment of FIGS. 3A-3J, the sheet 52, since it has the shape of the specific electronic device 60, has a shape that corresponds to an Apple® iPhone 5. In the illustrated embodiment, the dimensions of the sheet 52 are approximately 4.88 inches by 2.31 inches.

Also, although in the illustrated embodiment of FIGS. 3A-3J, the sheet 52 has the shape of the specific electronic device 60, an Apple® iPhone 5, in other embodiments (not shown), the sheet has a shape that corresponds to the display 62 of an Apple® iPhone 5. Thus, in one embodiment, the sheet 52 has dimensions of approximately 3.56 inches by 2.04 inches.

As illustrated in FIGS. 3D-3F, the first side 54 and the second side 56 include the tracing area 58. When the manufacture 50 is installed to the electronic device 60 the tracing area 58 substantially aligns with the display 62 of the electronic device 60 and the size of the tracing area 58 substantially corresponds to the size of the display 62. In the illustrated embodiment, the tracing area 38 has dimensions of approximately 3.56 inches by 2.04 inches.

As illustrated in FIGS. 3G-3J, the manufacture 50 includes the adhesive 13 that is applied to at least one portion 55 of the second side 56 of the sheet 52. The adhesive 13 assists or allows the manufacture 50 and/or the sheet 52 to adhere to the electronic device 60 or the display 62 of the electronic device 60.

When the manufacture 50 and/or the sheet 52 is installed to the electronic device 60 or the display 62 of the electronic device 60 figures or images, such as the FIG. 64, displayed on the display 62 of the electronic device 60 are visible in the tracing area 58 through the transparent or semitransparent material of the sheet 52.

FIGS. 3D-3F illustrate the exemplary manufacture 50 installed or adhered to the electronic device 60 such that the FIG. 64 displayed on the display 62 of the electronic device 60 is visible in the tracing area 58. In the illustrated embodiment of FIGS. 3D-3F, a user may trace the FIG. 64 onto the tracing area 58 of the manufacture 50 by marking the first side 54 with a writing device (e.g., pencil, pen, marker, etc.)

FIG. 3G illustrates an embodiment where the adhesive 13 is applied to portion 55a of the second side 56 on the outer area 59. The portion 55a is at or near the top edge of the sheet 52. In this embodiment, the manufacture 50 adheres to a portion of the electronic device 60 above the display 62 such that the tracing area 58 substantially aligns with the display 62.

FIG. 3H illustrates an embodiment where the adhesive 13 is applied to portion 55b of the second side 56 on the outer area 59. The portion 55b is at or near the right edge of the sheet 52. In this embodiment, the manufacture 50 adheres to a portion on the right of the device 60 such that the tracing area 58 substantially aligns with the display 62. In another embodiment (not illustrated), the adhesive 13 is applied to a portion of the second side 56 that is at or near the left edge of the sheet 52. In this embodiment, the manufacture 50 adheres to a portion on the left of the electronic device 60 such that the tracing area 58 substantially aligns with the display 62.

FIG. 3I illustrates an embodiment where the adhesive 13 is applied to portions 55c and 55d of the second side 56 on the outer area 59. The portions 55c and 55d are at or near the top edge and the bottom edge, respectively, of the sheet 52. In this embodiment, the manufacture 50 adheres to portions of the electronic device 60 above and below the display 62 such that the tracing area 58 substantially aligns with the display 62.

FIG. 3J illustrates an embodiment where the adhesive 13 is applied to portions 55e, 55f, 55g and 55h of the second side 56 on the outer area 59. The portions 55e, 55f, 55g and 55h are at or near corners of the sheet 52. In this embodiment, the manufacture 50 adheres to portions of the electronic device 60 near its corners such that the tracing area 58 substantially aligns with the display 62.

The embodiments of FIGS. 3G-3J are merely exemplary and other combinations of the portions 55 to which the adhesive 13 is applied may exist. Thus, the adhesive 13 may be applied to a single portion of the second side 56 on the tracing area 58 (including the whole tracing area 58) or the outer area 59 (including the whole outer area 59) or to two or more portions of the second side 56 corresponding to non-adjacent and non-overlapping portions of the tracing area 58 or the outer area 59.

While example systems, methods, and so on, have been illustrated by describing examples, and while the examples have been described in considerable detail, it is not the intention to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, and illustrative examples shown or described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (3D. Ed. 1995).

What is claimed is:

1. A manufacture for tracing figures from a display of an electronic device, the manufacture comprising:
a sheet of a transparent or semitransparent material having a shape corresponding to a shape of the electronic device or the display of the electronic device, a first side and a second side, the first side and the second side including a tracing area configured for a figure displayed on the display of the electronic device to be visible in the tracing area through the transparent or semitransparent material; and
an adhesive applied to at least a portion of the second side of the sheet for the manufacture to adhere to the electronic device or the display of the electronic device such that the figure displayed on the display of the electronic device is visible in the tracing area through the transparent or semitransparent material such that a user may trace the figure on the tracing area by marking the first side with a writing device.

2. The manufacture of claim 1, wherein the sheet comprises an outer area adjacent the tracing area, wherein the tracing area substantially corresponds to the display of the electronic device and the outer area to positions of the electronic device adjacent the display.

3. The manufacture of claim 2, wherein the outer area includes an area surrounding the tracing area, and wherein the adhesive is applied to a portion of the second side of the sheet corresponding to the area surrounding the tracing area.

4. The manufacture of claim 2, wherein the adhesive is applied to portions of the second side corresponding to non-adjacent and non-overlapping portions of the outer area.

5. The manufacture of claim 4, wherein the adhesive is applied to at least two portions of the second side corresponding to non-adjacent and non-overlapping portions of the outer area.

6. The manufacture of claim 4, wherein the adhesive is applied to at least four portions of the second side corresponding to non-adjacent and non-overlapping portions of the outer area.

7. The manufacture of claim 1, wherein the adhesive is applied to a portion of the second side of the sheet corresponding to a portion of the tracing area.

8. The manufacture of claim 7, wherein the adhesive is applied to a portion of the second side of the sheet corresponding to substantially the whole tracing area.

9. The manufacture of claim 1, where the dimensions of the sheet are approximately 9.50 inches by 7.31 inches.

10. The manufacture of claim 1, where the dimensions of the sheet are approximately 7.87 inches by 5.30 inches or approximately 4.88 inches by 2.31 inches.

11. The manufacture of claim 1, where a ratio of a first dimension to a second dimension of the tracing area is 4:3.

12. The manufacture of claim 1, where a ratio of a first dimension to a second dimension of the tracing area is 16:9.

13. The manufacture of claim 1, wherein the adhesive is applied to portions of the second side adjacent the tracing area at at least two of above, below, right, and left of the tracing area.

14. A method of tracing figures from a display of an electronic device, the method comprising:
installing a sheet of a transparent or semitransparent material having a shape corresponding to a shape of the electronic device or the display of the electronic device on the electronic device, the sheet having:
a first side and a second side, the first side including a tracing area configured for a figure displayed on the display of the electronic device to be visible in the tracing area through the transparent or semitransparent material, and
an adhesive applied to at least a portion of the second side of the sheet for the manufacture to adhere to the electronic device or the display of the electronic device,
wherein upon the installing of the sheet the figure displayed on the display of the electronic device is visible in the tracing area through the transparent or semitransparent material; and
tracing the figure on the tracing area by marking the first side with a writing device.

15. The method of claim 14, wherein
the adhesive is applied to portions of the second side adjacent the tracing area at at least two of above, below, right, and left of the tracing area, and
the installing of the sheet includes pressing of the sheet against the electronic device such that the sheet adheres to the electronic device.

16. A method of manufacturing a manufacture for tracing figures from a display of a specific electronic device, the method comprising:
producing a sheet of a transparent or semitransparent material having a shape corresponding to a shape of the specific electronic device or the display of the specific electronic device, the sheet having a first side and a second side, the first side and the second side including a tracing area configured for a figure displayed on the display of the electronic device to be visible in the tracing area through the transparent or semitransparent material; and
applying an adhesive to portions of the second side including at least one of:
adjacent the tracing area at at least two of above, below, right, and left of the tracing area, and
a portion corresponding to the tracing area.

17. The method of claim 16, where the producing the sheet includes producing the sheet with dimensions of approximately 9.50 inches by 7.31 inches.

18. The method of claim 16, where the producing the sheet includes producing the sheet with dimensions of approximately 7.87 inches by 5.30 inches or approximately 4.88 inches by 2.31 inches.

19. The method of claim 16, where the producing the sheet includes producing the sheet with a ratio of a first dimension to a second dimension of the tracing area of 4:3.

20. The method of claim 16, where the producing the sheet includes producing the sheet with a ratio of a first dimension to a second dimension of the tracing area of 16:9.
